(19) United States
(12) Patent Application Publication
(10) Pub. No.: US 2009/0225028 A1
(43) Pub. Date: Sep. 10, 2009

(54) POINT AND CLICK DEVICE FOR COMPUTER

(76) Inventors: Clem Abrams, La Jolla, CA (US); Tharold E. Northup, San Diego, CA (US); Richard A. Dean, La Jolla, CA (US); Marin Dinca, San Diego, CA (US)

Correspondence Address: ROSS PATENT LAW OFFICE, P.O. BOX 2138, DEL MAR, CA, 92014, US

(21) Appl. No.: 12/392,919

(22) Filed: Feb. 25, 2009

Related U.S. Application Data
(60) Provisional application No. 61/067,159, filed on Feb. 26, 2008.

(51) Int. Cl. G06F 3/033

(52) U.S. Cl. 345/161

(57) ABSTRACT

A pointing device for controlling cursor operation on a computer monitor screen. An operator controls the motion of a movable reflective surface. A stationary light source directs light onto the movable reflective surface and the light is reflected to a stationary light sensor. A signal processor receives signals generated by the stationary light sensor based on light reflected from the movable reflective surface. The processed signals are transferred to a computer processing unit and are utilized to move a cursor across a monitor screen in a manner that corresponds to the motion of the movable reflective surface. In a preferred embodiment the light source is a laser light source. Also, in a preferred embodiment, two joysticks are provided in front of the keyboard space bar. The joysticks are used to control the motion of the movable reflective surface and right/left clicking with the thumbs of the keyboard operator while his fingers are kept in an appropriate position for typing on a computer keyboard.

This application claims the benefit of Provision Application Ser. No. 61/067,159, filed Feb. 26, 2008. The present invention relates to personal computers and in particular to pointing devices for personal computers.

### BACKGROUND OF THE INVENTION

The personal computer has become a modern fixture in businesses and residences. Users of personal computers typically interface with their laptops and desktop computers by typing on a keyboard and looking at images on a screen. Additionally, pointing devices, such as a computer mouse, allow for increased interface capability through a point-and-click method.

The current optical mouse, developed by Agilent Technologies was introduced to the world in late 1999. The operation of the mouse is such that moving an optical mouse over a flat surface allows the x and y distances moved to be transferred into pointing the cursor on the computer monitor. The optical mouse uses a tiny camera to take thousands of pictures every second. It is able to work on almost any surface without a mouse pad. Most optical mice use a small, light-emitting diode (LED) that bounces light off a surface onto a complimentary metal-oxide semiconductor (CMOS) sensor. In addition to LEDs, a recent innovation is a laser-based optical mouse that detects more surface details compared to LED technology. This results in the ability to use a laser-based optical mouse on even more surfaces than an LED mouse.

The sensor and other parts of an optical mouse work together in the following fashion:
1) The CMOS sensor sends each image to a digital signal processor (DSP) for analysis,
2) The DSP detects patterns in the images and examines how the patterns have moved since the previous image,
3) Based on the change in patterns over a sequence of images, the DSP determines how far the mouse has moved and sends the corresponding coordinates to the computer,
4) The computer moves the cursor on the screen based on the coordinates received from the mouse. This happens hundreds of times each second, making the cursor to appear to move very smoothly.

The use of a laser mouse is based on the same idea except it uses a narrow beam of light that is reflected off the surface producing an image with greater contrast that is captured by a higher resolution sensor (1600 dpi) at a higher rate, of up to 6000-7000 times per second. Because of this advancement, laser can track where optical cannot, such as clear glass. Currently laser mice are taking over the optical mice.

Typical optical mice elements are separate from the keyboard or are positioned on the keyboard but require that the keyboard operator take his hands off the keys of the keyboard to operate the mouse element. The current mouse-keyboard interface is problematic due to the need to move back and forth from the computer keyboard to the mouse to make operations occur. The operator must remove one of his hands from the appropriate typing position in order to grab and operate a mouse. Significant time can be lost moving the hand from the keyboard, grabbing the mouse, operating the mouse and then moving the hand back to the keyboard.

What is needed is a better pointing device for computers.

### SUMMARY OF THE INVENTION

The present invention provides a pointing device for controlling cursor operation on a computer monitor screen. An operator controls the motion of a movable reflective surface. A stationary light source directs light onto the movable reflective surface and the light is reflected to a stationary light sensor. A signal processor receives signals generated by the stationary light sensor based on light reflected from the movable reflective surface. The processed signals are transferred to a computer processing unit and are utilized to move a cursor across a monitor screen in a manner that corresponds to the motion of the movable reflective surface. In a preferred embodiment the light source is a laser light source. Also, in a preferred embodiment, two joysticks are provided in front of the keyboard space bar. The joysticks are used to control the motion of the movable reflective surface and right/left clicking with the thumbs of the keyboard operator while his fingers are kept in an appropriate position for typing on a computer keyboard.

### BRIEF DESCRIPTION OF THE DRAWINGS

FIG. 1 shows a preferred embodiment of the present invention.

FIGS. 2A-11C show an example of the operation of a preferred embodiment of the present invention.

FIG. 12 shows a preferred pointing device connected to a keyboard.

FIGS. 13-16 show some components of a preferred pointing device.

FIGS. 17-18 show a collapsible stem.

FIG. 19 shows a preferred laser light-sensor unit.

FIGS. 20-21 show a preferred embodiment of the present invention.

FIG. 22 shows another preferred embodiment of the present invention.

FIGS. 23A-23B show another preferred embodiment of the present invention.

### DETAILED DESCRIPTION OF PREFERRED EMBODIMENTS

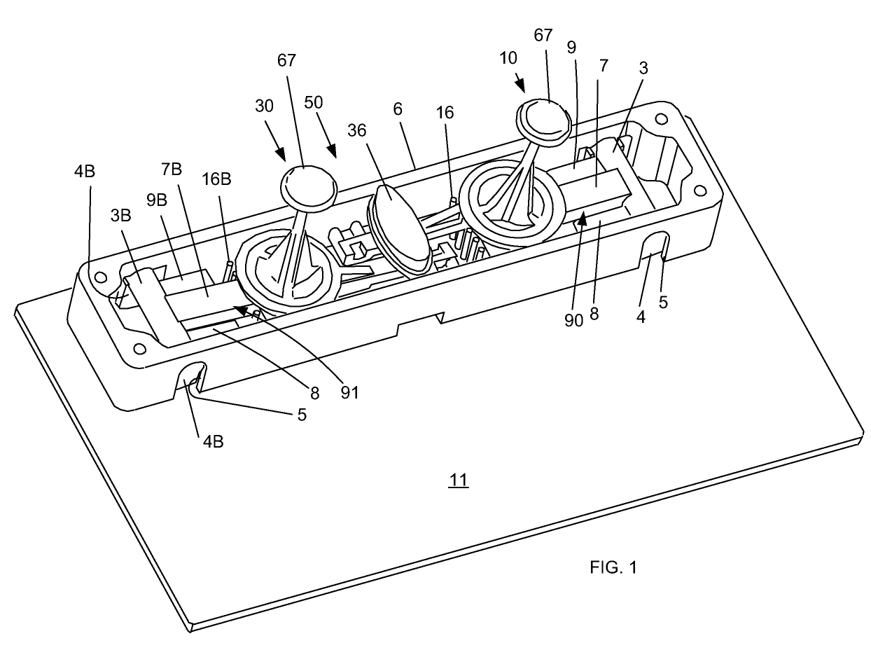

The present invention includes pointing device 50. Pointing device 50 (FIG. 1) operates in reverse of a traditional mouse. That is, instead of operating like a traditional mouse and moving the light, camera and sensor over a flat surface (i.e., a table or a mouse pad), a curved surface is moved over a stationary light, camera, and sensor system by the operator's thumbs allowing the fingers to remain over the key board at all times. This is a drastic improvement over the prior art. Now, an operator can keep his fingers in the appropriate positions for typing and at the same time operate a pointing device with his thumb. The result is a significant savings in time spent inputting information into a computer.

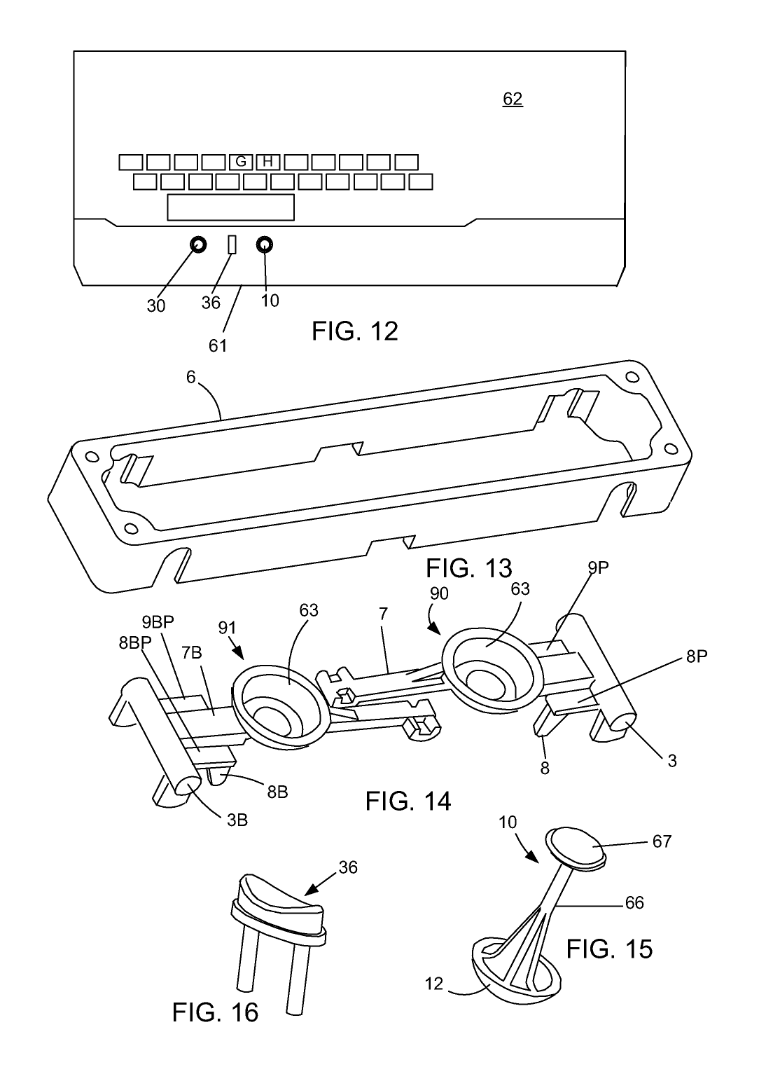

A preferred embodiment of the present invention is shown in FIG. 12. Joysticks 10 (and 30) and scroll rocker 36 are contained within wrist-rest 61. As indicated in FIG. 15, joysticks 10 and 30 are used to orbit a small curved reflector surface (pivot ball 12) above a laser light-sensor unit to control cursor movement on the computer monitor. In effect, this moves a ‘curved table’ over a stationary laser.

As shown in FIG. 12, wrist-rest 61 contains pointing device 50 and is attached to the separate keyboard 62. It should be noted that in another preferred embodiment device 50 could also be incorporated into a keyboard that has a built in wrist rest. Keyboard 62, joysticks 10 and 30, and scroll rocker 36 are utilized to allow an operator to input information into a personal computer. In a preferred embodiment of the present invention, an operator places both hands over keyboard 62 in the normal typing position. The operator's right thumb is used to manipulate joystick 10. Normally, when the operator is typing words into the computer, he does not need to use a pointing device. Therefore, the joysticks are configured so that if they are inadvertently bumped then they will not affect the position of the cursor on the screen.

However, when the operator presses joystick 10 downward with his thumb he moves the bottom rounded part of the joystick (pivot ball 12) into a region so that its motion is detected and sensed by a laser light-sensor unit which is adapted to transmit signals to a movement processor which controls the position of the cursor. When pivot ball 12 has been appropriately lowered, any circular or left-right-forward-backward movement of the joystick by the thumb will cause the cursor to move around the monitor screen. In addition, when the cursor is in a desired location, the right thumb can be pushed even further down to activate a pull-down menu. Or when the cursor is in a desired location, the left thumb is used to depress joystick 30 downward to fix the cursor at a specific spot. Either thumb may be used to press down on scroll bar 36.

Reverse operation via a software driver program is provided for left-handed operator. For example, a left-handed person may want to be able to manipulate the location of the cursor spot on the monitor or pull down a menu by using his left thumb. Likewise in the reverse operation mode, the right thumb would be used to locate the cursor at a spot on the monitor.

In a preferred embodiment, the joystick stem can be collapsed to allow the joystick to be lowered below the space key and out of the way when not required for operation. The joystick elevation is adjustable to vary the height relative to the top of the space bar for comfortable operation by the user. Communication between the movement processor and monitor cursor is via blue tooth, USB, or via other wireless or wire means.

### A Preferred Embodiment of the Present Invention

FIG. 1 shows some of the components of a preferred embodiment. Pivot arms 7B and 7 are connected to printed circuit board 11 via legs 4B and 4, respectively. Joysticks 10 and 30 are seated in pivot arms 7 and 7B. Laser light sensors are positioned below joysticks 7B and 7 and function to detect the motion of the joysticks. Housing 6 is attached to printed circuit board 11. Thumb shoes 67 at the top of joysticks 10 and 30 provide for control of cursor operation. Thumb shoes 67 are moved in a 360 circular or x-y direction to provide movement of the cursor on the monitor.

Pivot ball 12 is placed into the laser light by a slight downward pressure on thumb shoe 67 by the thumb. The right thumb presses downward opposing a spring force generated by pivot arm 7 and spring leg 9. The downward movement puts the curved surface of pivot ball 12 in the field of the light-sensor so that the light wave pattern can be measured and transferred into movement of the cursor in its X-Y coordinates on screen 20, FIG. 21.

Upon release of the user's thumb force, the spring force in the pivot arm returns pivot ball 12 to its normal centered vertical position taking the curved surface out of the light field. Preferably, when the cursor is not moved completely to the spot desired on monitor 20 a release of the joystick 10 and subsequent reapplication of the downward motion on thumb shoe 67 enables continuation of cursor movement to the spot desired on monitor 20. This is similar to picking up and moving a conventional mouse to a new spot on the mouse pad to obtain more cursor movement space.

### Operation of a Preferred Embodiment

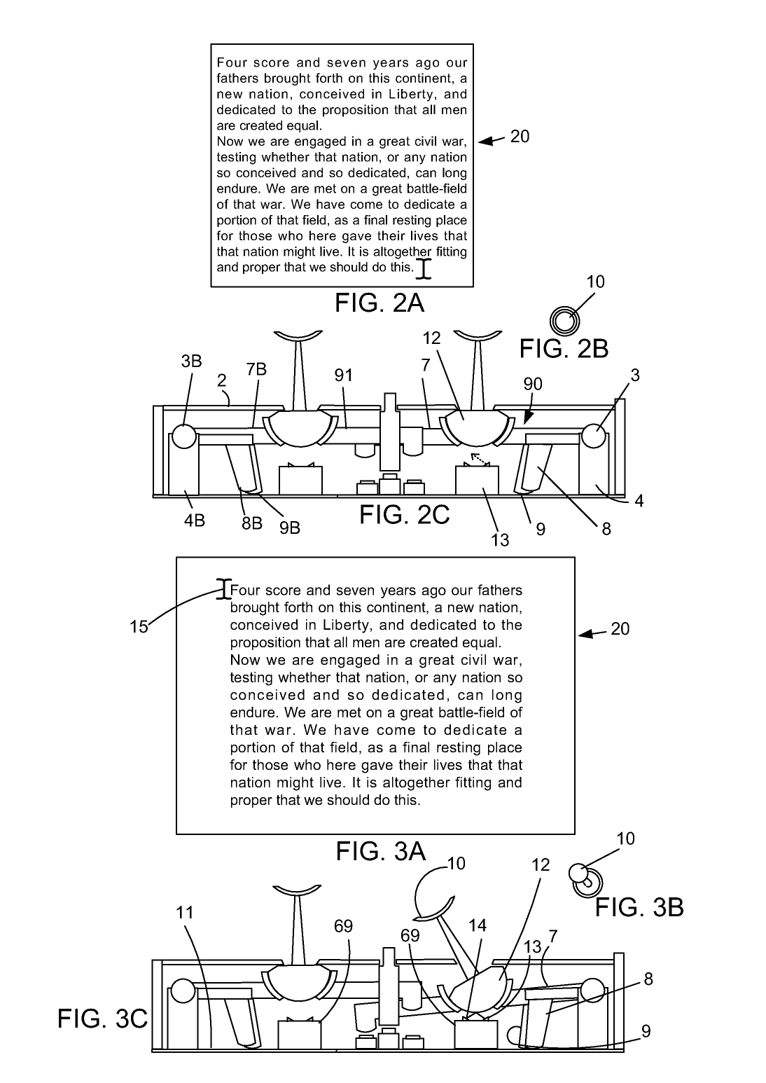

FIG. 1 shows a perspective view of preferred pointing device 50 having thumb-operated joysticks 10 and 30 for controlling cursor movement and FIGS. 2-11 show simplified side views depicting the operation of the joysticks. Joysticks 10 and 30 are each supported by pivot ball holders 90 and 91, FIG. 13, respectively.

As shown in FIG. 2C, pivot axis 3 of pivot ball holder 90 is rigidly support by pivot legs 4. Pivot legs 4 are rigidly support by slots 5 of housing 6 and are thereby kept stationary and prevented from movement. Pivot arm 7 is rigidly connected to pivot axis 3. In a preferred embodiment, spring legs 8 and 9 are also connected to pivot axis 3. Spring leg 9 is slightly longer than spring leg 8 and is further from pivot axis 3 than spring leg 8. Spring leg 9 is in contact with the top of printed circuit board 11. The bottom of spring leg 8 is slightly elevated above the top of circuit board 11. Spring legs 8 and 9 are each connected to pivot axis 3 via their own pivot arms. For example, pivot arm 8P for spring leg 8 is shown in FIG. 14. Likewise similar features are associated with pivot ball holder 91.

A simple example of the operation of thumb operated pointing device 50 is shown by reference to FIGS. 2A-11C.

In FIGS. 2A-2C an operator has typed a selection from the Gettysburg Address and has decided that he wants to edit the selection. Both joysticks are vertical and in their neutral position. Pivot ball 12 is above the laser light path from laser 13. Therefore, if joystick 10 is inadvertently bumped the cursor will not move across the monitor screen shown in FIG. 2A.

In FIGS. 3A-3C the operator has pressed down on joystick 10 with his thumb. Pivot arm 7 and spring leg 9 both act together as a spring to resist the force imparted by the operator's thumb. However, the operator can easily overcome the resistance with minimal thumb force. As the operator continues to press downward with his thumb, spring leg 8 comes into contact with the top of circuit board 11. The increased resistance is felt by the operator and is a signal to the operator that pivot ball 12 of joystick 10 is in the appropriate position to reflect light from laser 13 so that sensor 14 can properly read the light. The operator then refrains from increasing the downward thumb force and instead maintains pivot ball 12 at the appropriate level for good reflection. From this location, the operator can maneuver the joystick is a circular or linear fashion so that cursor 15 is positioned as desired. As shown in FIGS. 3A-3B, the operator moves joystick 10 forward and to the left so that cursor 15 is at the beginning of the Gettysburg Address in front of the word “Four”.

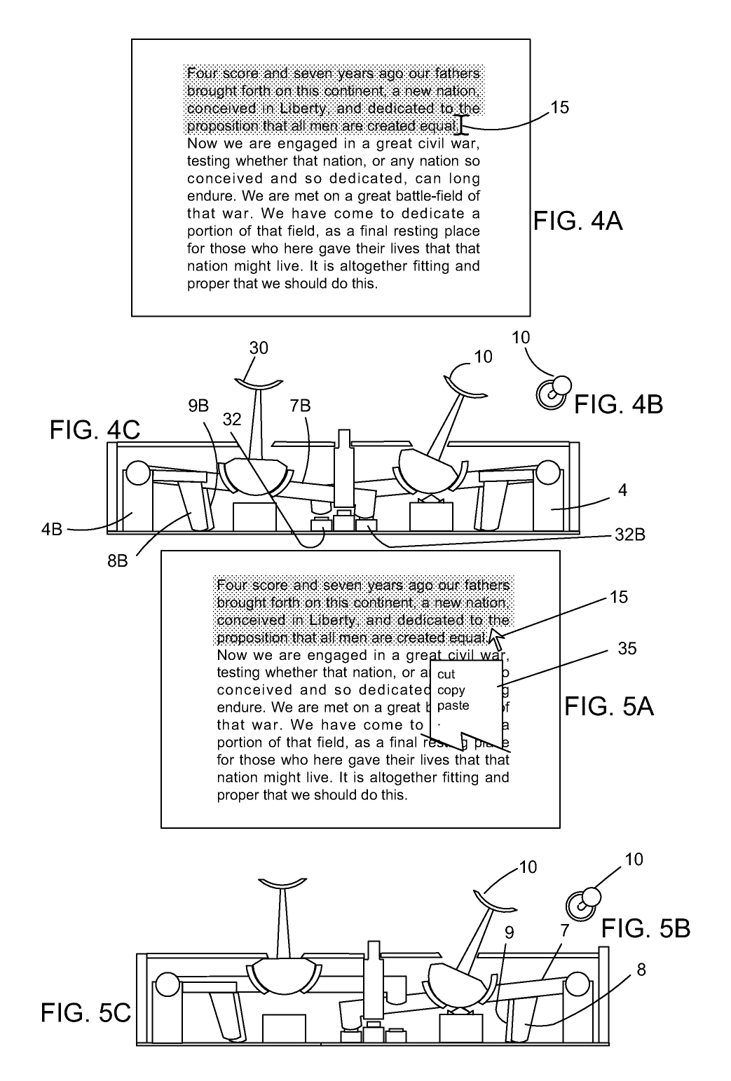

In FIGS. 4A-4C, while cursor 15 was positioned in front of the word “Four” as shown in FIG. 3A, the operator pressed downward on joystick 30 with his left thumb overcoming the increase in spring resistance offered by pivot arm 7B and spring legs 8B and 9B. This has caused the end of pivot arm 7B to press downward on micro switch 32B. Micro switch 32B controls the left-click function of pointing device 50. After left-clicking, the operator continues to hold down joystick 30 with his thumb so that micro switch 32B continues to depress. The operator then moves cursor 15 to the position shown in FIG. 4A so that it is located after the word “equal”. The operator then releases thumb pressure on joystick 30. The operator has selected the words “Four score and seven years ago our fathers brought forth on this continent, a new nation, conceived in Liberty, and dedicated to the proposition that all men are created equal.”

In FIGS. 5A-5C, the operator has increased the thumb pressure on joystick 10, overcoming the spring resistance offered by pivot arm 7, spring leg 9 and the further spring resistance of spring leg 8. Micro switch 32 is consequently pressed downward. Micro switch 32 controls the right-click function of pointing device 50. By right-clicking pointing device 50, the operator has brought up menu 35 and cursor 15 now appears as an arrow.

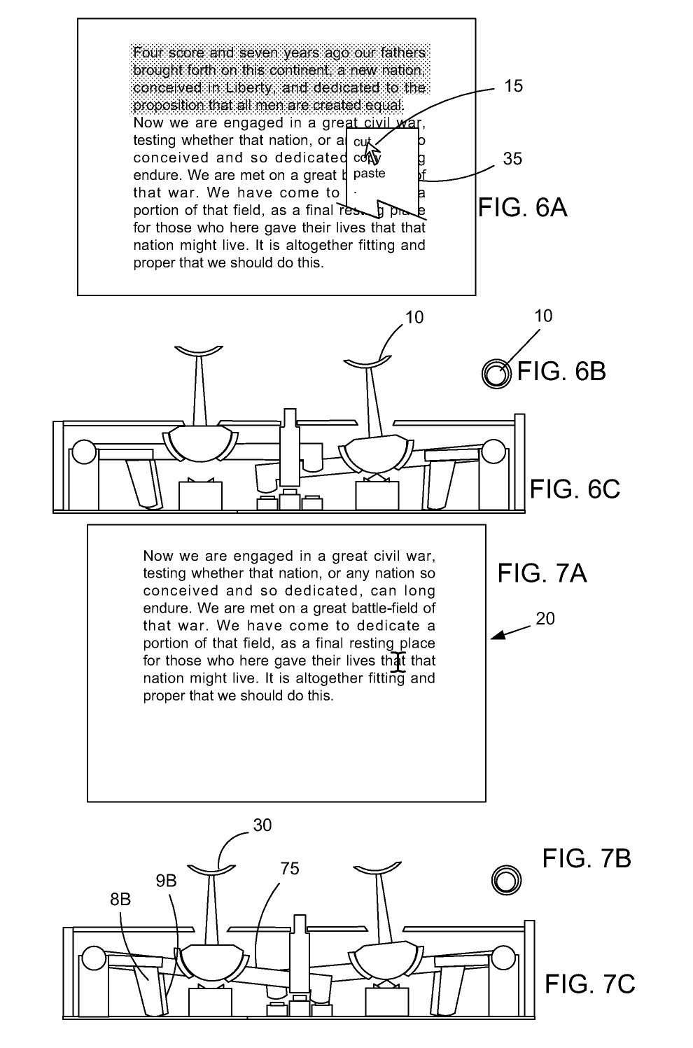

In FIGS. 6A-6C, the operator has moved cursor 15 to the left and downward slightly so that cursor 15 points to the word “cut” on menu 35.

In FIGS. 7A-7C, the operator has pressed downward on joystick 30 with his left thumb overcoming the spring resistance offered by pivot arm 7B and spring legs 8B and 9B. This has caused the end of pivot arm 7B to press downward on micro switch 32B to activate the left-click function of pointing device 50. After left-clicking the word “cut”, the selected text from FIG. 6A no longer appears on screen 20.

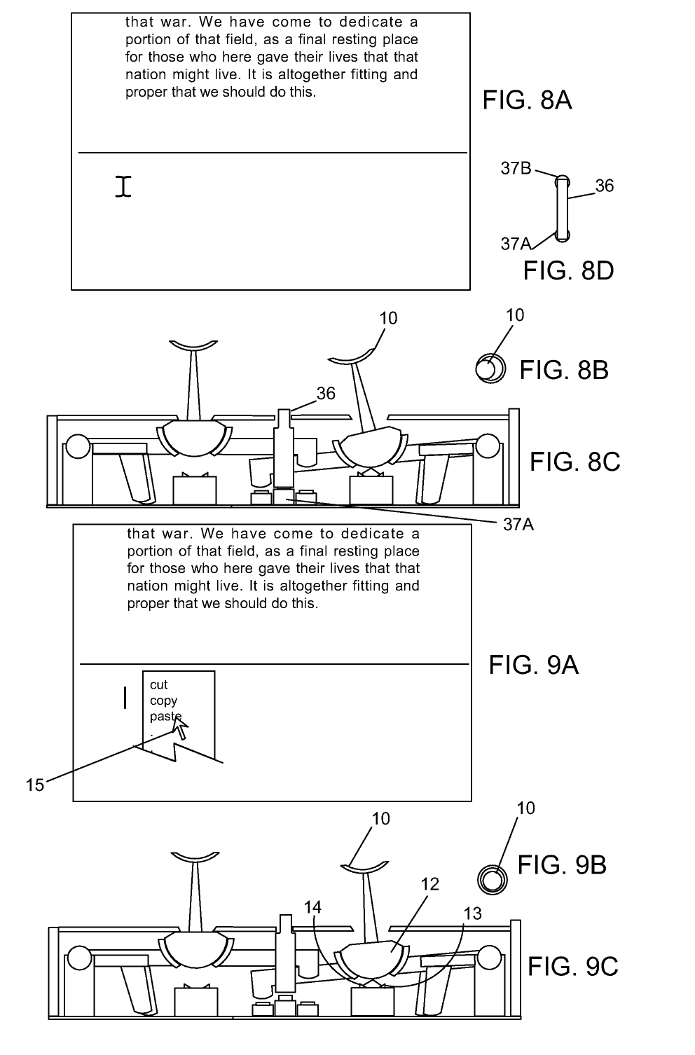

In FIGS. 8A-8C, the operator has scrolled down the page by pressing on the bottom part of scroll rocker 36. This has caused scroll rocker 36 to press down micro switch 37B. Pressing micro switch 37B causes the page viewed on screen 20 to scroll downward. As shown in FIG. 8A, the operator has scrolled downward to the next page. In addition to scrolling downward, the operator has moved joystick 10 left and downward so that cursor 15 is positioned as shown.

In FIGS. 9A-9C, the operator has right-clicked by pressing downward on joystick 10 to bring up menu 35. Then, the operator has slightly eased pressure on joystick 10 so that pivot ball 12 is in the appropriate position to reflect light from LASER 13 so that sensor 14 can properly receive the light. Then, the operator has moved joystick 10 slightly to the left so that cursor 15 is pointing at the word “paste”.

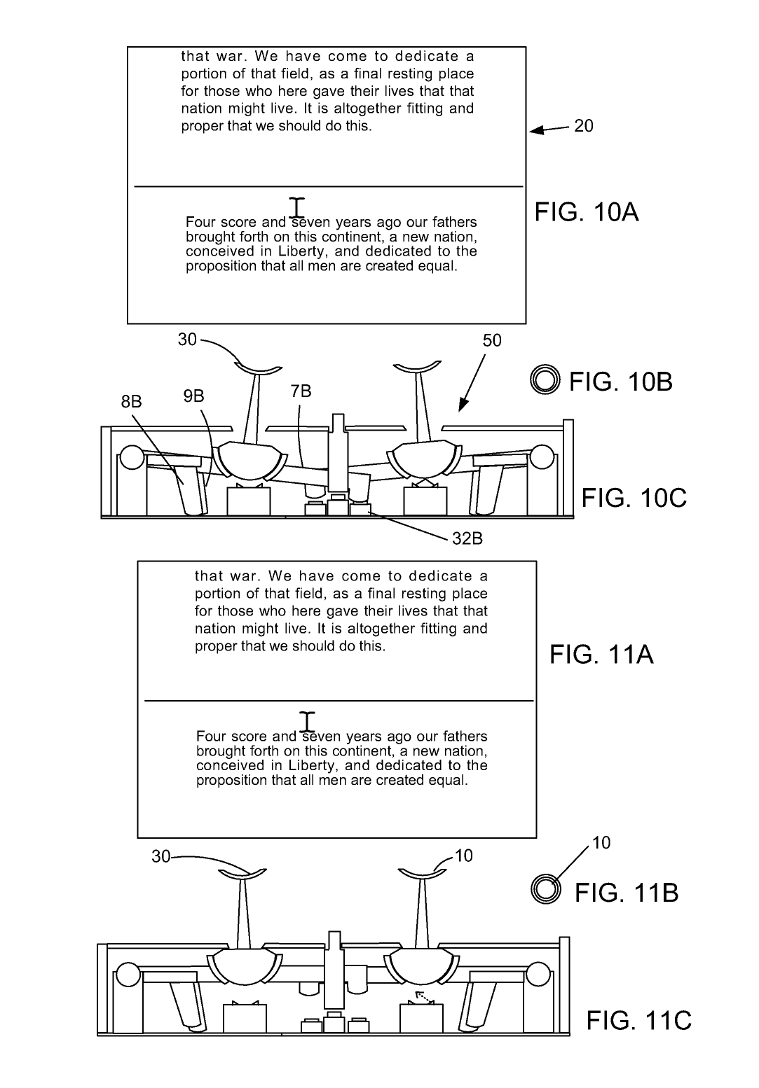

In FIGS. 10A-10C, the operator has pressed downward on joystick 30 with his left thumb overcoming the spring resistance offered by pivot arm 7B and spring legs 8B and 9B. This has caused the end of pivot arm 7B to press downward on micro switch 32B to activate the left-click function of pointing device 50. After left-clicking the word “paste”, the selected text from FIG. 6A appears at the position shown on screen 20.

In FIGS. 11A-11C, the operator has released thumb pressure on joysticks 10 and 30. The document is now ready for further editing.

### Preferred Components

### Housing

FIG. 13 shows housing 6. Housing 6 is sized to house all of the mechanical parts and is configured so that key parts could be snapped into place without supplemental fasteners. In a preferred embodiment, the top to housing 6 is wrist-rest 61 (FIG. 12) and the bottom is printed circuit board 11 (FIG. 1).

### Pivot Arms

FIG. 14 shows pivot arms 7 and 7B of pivot ball holders 90 and 91, respectively. As explained above, pivot ball holders 90 and 91 are preferably snapped into housing 6 and they rest on circuit board 11 so that they are held firmly in place. Pivot arm 7 is connected to pivot axis 3 and pivot arm 7B is connected to pivot axis 3B. As shown above, pivot arm 7 holds joystick 10 and pivot arm 7B holds joystick 30.

The pivot arms, preferably, provide several functions. When the operator is not pressing down on the joystick with his thumb, the pivot arm forces the top part of pivot ball 12 (FIG. 15) up against the underside of the wrist-rest 61 to maintain the joystick in a neutral vertical position when not in use. Pivots arm 7B and 7, with ball holders 90 and 91, are both sized, configured and made of material that provides the ‘spring action’ that keeps the joystick in its neutral position. A preferred material is plastic.

Pivot arms 7 and 7B each include concave holders 63 to support pivot balls 12. Concave holders 63 allow for fluid motion of pivot balls 12 while the joysticks are being utilized.

Pivot arms 7 and 7B also provide spring resistance to movement of pivot ball 12 into the laser light to activate movement of the curser on the computer monitor. Downward thumb force on joystick 10 moves pivot ball 12 into the laser light. Preferably, this movement is adjustable between 0.125 inches and 0.032 inches. As shown above, thumb rotation of joystick 10 places the curser where desired.

### Spring Resistance to the Motion of the Pivot Arms

As explained above, pivot arm 7 is rigidly connected to pivot axis 3 and some spring resistance is provided by virtue of this connection alone. Additional spring resistance is provided by spring legs 8 and 9. Spring legs 9 and 8 each have their own pivot arms 9P and 8P. Preferably, spring leg 9 extends (FIGS. 2-11) longer than spring leg 8 and pivot arm 9P is longer than pivot arm 8P. Spring leg 8 adds resistance to thumb movement beyond getting the pivot ball 12 into the laser light. This resistance is used to let the operator know he is at the appropriate position for cursor control and to prevent the accidental activation of the micro switch 32 (FIG. 4C) below the pivot arm 7 until ready. By placing the curser where desired by the right thumb, the left thumb is used to overcome the spring leg 8B and activate selection micro switch 32B (FIG. 4C). Pivot arm 7 can then be used to press down on micro switch 32 to activate pull down menus.

### Joystick

Joystick 10 is shown in FIG. 15 and includes pivot ball 12. Preferably, pivot ball 12 is approximately one half of a sphere having a 0.625 inch outer diameter. Stem 66 is attached between pivot ball 12 and thumb shoe 67.

The two holes cut into wrist-rest 61 are sized to let the stem 66 of joysticks 10 and 30 to pass through and rotate during operation but not pivot ball 12 (FIG. 12). Thumb shoe 67 is screwed onto joystick stems when in place. The pivot ball surface, when in operation, is kept above the laser at a constant distance so that the reflective light can be accurately measured and transformed into movement of the curser on the computer monitor.

### Joystick with Adjustable Height

In another preferred embodiment joystick 10 is adjustable in height to accommodate user's hand. For example, thumb shoe 67 can be attached via threads so that it can be threaded up or down on stem 66 to the desired height.

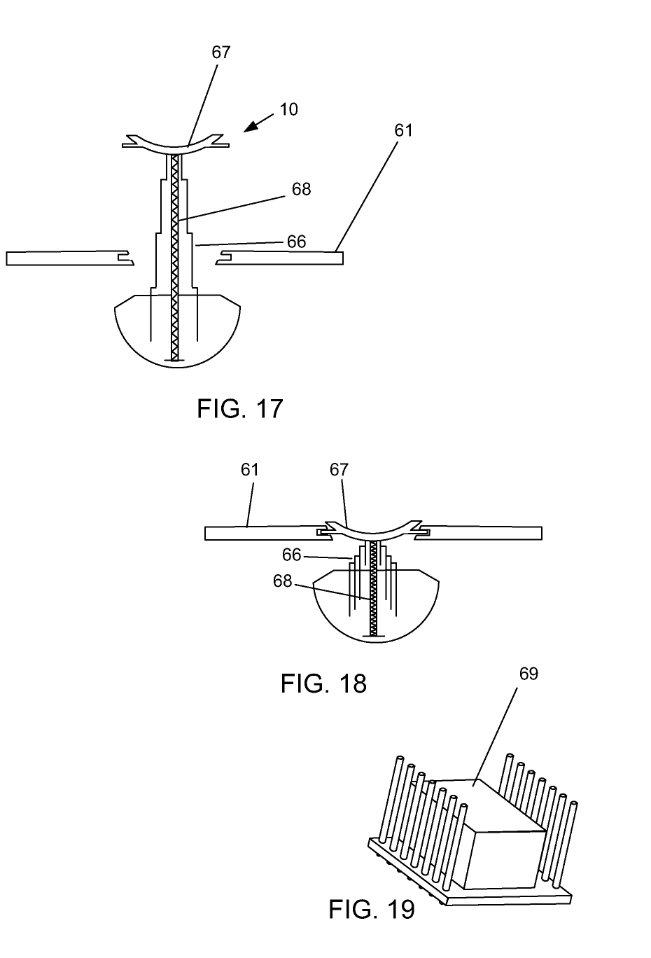

In another preferred embodiment joystick 10 is collapsible because on some occasions the user may not want to utilize the joysticks. For example, FIG. 17 shows spring 68 contained within collapsible stem 66. In FIG. 18 the operator has pressed downward on thumb shoe 67 and stem 66 has collapsed and spring 68 has compressed. Thumb shoe 67 is held approximately level with wrist-rest 61 via tabs engaged with grooves in wrist-rest 61.

### Scroll Rocker

FIG. 16 shows scroll rocker 36. Positioned between joysticks 10 and 30, scroll rocker 36 operates two micro switches 37A and 37B (FIGS. 8C and 8D) to provide up and down movement of the curser on the computer monitor. Side to side movement can also be provided by utilization of a similar pair of microswitches. Scroll rocker 36 is held in position by the wrist-rest 61 and the spring response in micro switches 37A and 37B.

### Laser Light Sensor Unit

FIG. 19 shows a perspective view of laser light-sensor unit 69. Focusing the laser light from laser light-sensor unit 69 onto pivot ball 12 surface (FIG. 3C) allows a tiny camera to take thousands of pictures of the ball surface every second.

Sensor 14 (FIG. 3C) works in the following manner:
A high resolution complementary metal-oxide semiconductor (CMOS) optical sensor sends each image to a digital signal processor (DSP) for analysis.
The DSP detects patterns in the images and examines how the patterns have moved since the previous image.
Based on the change in patterns over a sequence of images, the DSP determines how far the surface has moved and sends the corresponding coordinates to the computer.
The computer moves the cursor on the screen based on the coordinates received from the mouse. This happens hundreds of times each second, making the cursor appear to move very smoothly.

The laser provides a narrow beam of light that is reflected off the surface producing an image with great contrast that is captured by the high resolution sensor at rates of up to 6000-7000 times per second.

### Signal Processor

Light impinging on the pivot ball 12 is reflected back into a sensor 14 (FIG. 3C) where movements of the surface of pivot ball 12 are measured and converted into x-y position coordinates by signal processor 77 (FIG. 21). Signal processor 77 sends the information to the signal transmitter 78 for wireless transfer to the dongle receiver 52 that is attached to the computer 51. This transmission moves the cursor on the monitor 20 screen. This cursor positioning method is similar to that of a conventional optical mouse except that the direction of the cursor movement is reversed in signal processor 77. A USB wire connection between the signal transmitter and dongle receiver 52 can also be used.

### Circuits

The circuits on circuit board 11 are arranged for applying power to laser light-sensor unit 69, taking pictures of the light spectrum on the curved reflective surface of pivot ball 12, collecting and analyzing the changes in movement, and sending the results to the signal transmitter 78 circuit for wireless movement to the dongle 52. The circuitry includes provisions for re-routing the controls from the right to the left thumb, controlling the speed and direction of cursor movement, and complete vertical and horizontal scrolling of the cursor. The scrolling circuitry uses programming logic to take the activation of two micro-switches to initiate the cursor movement up, down, or back and forth.

In the preferred embodiment, the circuits on circuit board 11 are powered from batteries 93. In another preferred embodiment the power is drawn from a USB direct connection to the computer. Battery power is the preferred embodiment as it allows pointing device 50 to be added to a normal keyboard where the space bar is close to the front of the keyboard.

### Wireless Transmission

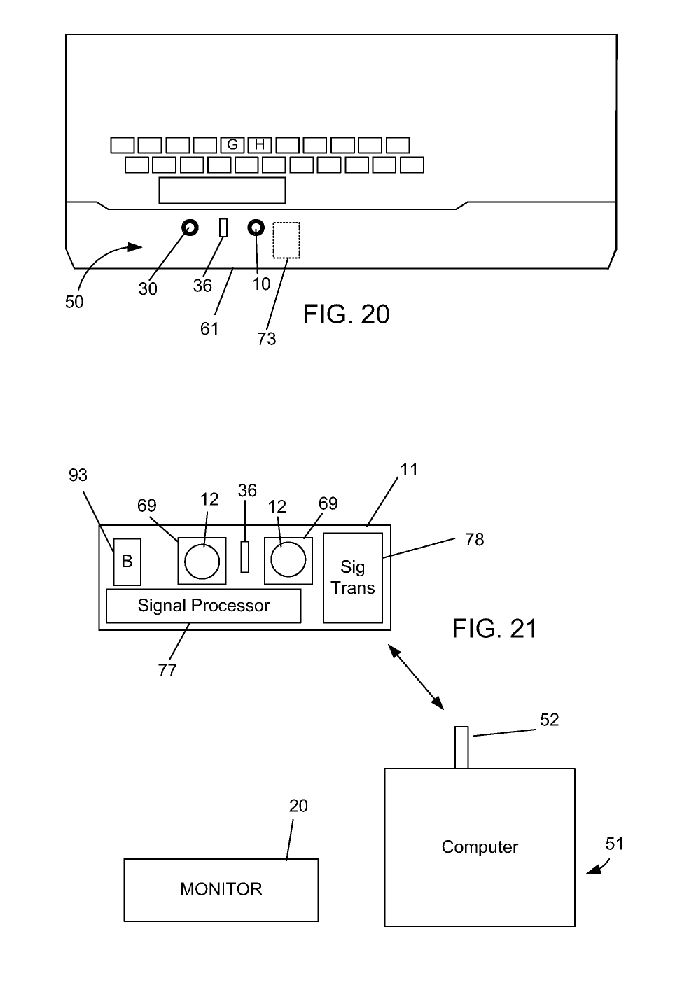

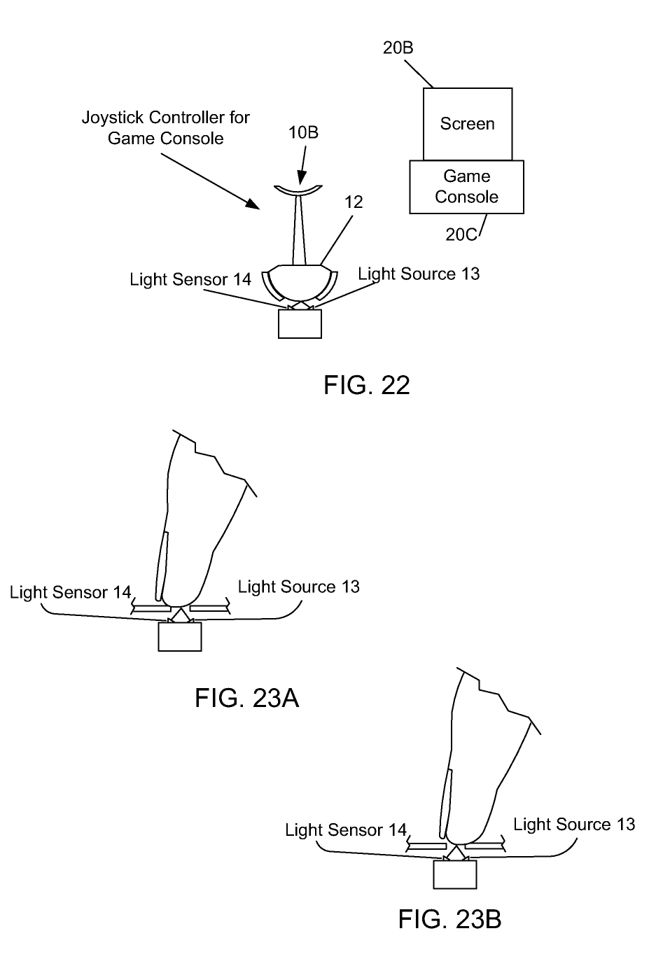

As shown in FIG. 20, in a preferred embodiment pointing device 50 transmits its cursor control signals to computer 51 via wireless transmission by utilization of dongle 52 attached to a USB port of computer 51.

### Other Preferred Embodiments

### Activation of Light Sensor

The downward movement of joysticks 10 and 30 is replaced by placing a very low capacitive charge on thumb shoes 67 so that when the thumb touches it, laser 13 and sensor 14 and the laser light-sensor unit circuit is activated and deactivated when the thumb is removed. This removes the requirement for a spring arm action to control the downward movement of the joysticks. However, a centering spring reaction is still required to return the joystick to its vertical at-rest position when not in use.

### Flat Bottomed Joystick

Instead of having pivot ball 12 at the bottom of joysticks 10 and 30, the bottom of each joystick can be flat. The movement of a flat plate surface can also accomplish the thumb-activated movement of a surface over a stationary light-sensor source. The x-y rotation pivot provides the pivot point. The surface plate can be flat and held in x-y position by springs that return the plate to a neutral state. The varying length stem with a light return spring will allow the plate to be moved into the laser light and rotated in a full 360-degree circle while maintaining the x-y direction orientations.

### Track Ball

In another preferred embodiment the joysticks can be replaced with track balls. The track balls can be controlled by the user's thumb and their convex surface will move over the stationary light-sensor source in a fashion similar to that described above in reference to the joysticks.

### Finger Control

Another preferred embodiment for the activation of the light sensor is through the use of any partial (very small) surface of a finger or thumb rather than by a joystick and pivot ball (FIGS. 23A and 23B). This embodiment takes advantage of the development of laser sensitivities exceeding 30,000 dots per inch to detect movement directions for transmission to the cursor. Considerable reduction of overall height occurs making its use in lap top computers easier to accomplish.

### Micro-Switches

While the preferred embodiment uses multiple micro-switches to select and activate the cursor spot, in another preferred embodiment a single micro-switch can be used to replicate the standard right and left click, as well as the activation of a scroll operation.

### Computer Software

In a preferred embodiment computer 51 (FIG. 21) is programmed to allow the operator the ability to customize the operation of pointing device 50. For example, by accessing software loaded onto computer 51, the user can choose whether he prefers joystick 10 or joystick 30 to control cursor 15 movements across monitor screen 20. The operator can also customize the clicking function of micro switches so that the right click function and left click function can be assigned to joystick 10 or joystick 30.

### Game Console Embodiment

In another preferred embodiment, joystick 10B is utilized in a computer game console to control character movement on monitor screen 20B. Laser light from light source 13 is directed onto pivot ball 12 and reflected back onto light sensor 14 in a manner similar to that described above. As joystick 10B is manipulated by the user signals received by sensor 14 are processed and are transferred to console 20C. A characters and/or objects depicted on screen 20B are moved across the screen in accordance with the operator controlled movement of joystick 10B. Dual joysticks, or thumb surfaces can be used where both thumbs are involved in game operation.

While the above description contains many specifications, the reader should not construe these as limitations on the scope of the invention, but merely as exemplifications of preferred embodiments thereof. Those skilled in the art will envision many other possible variations are within its scope. Accordingly the reader is requested to determine the scope of the invention by the appended claims and their legal equivalents, and not by the examples which have been given.

What is claimed is:

1) A pointing device for controlling cursor operation on a computer monitor screen, comprising:
A. a computer processing unit,
B. a computer monitor screen having a controllable cursor, said computer monitor screen connected to said computer processing unit,
C. at least one operator controlled movable reflective surface,
D. a stationary light source for directing light onto said at least one operator controlled movable reflective surface,
E. a stationary light sensor for receiving reflected light from said at least one operator controlled movable reflective surface and for generating signals based on said received reflected light, wherein said generated signals include information representative of the motion of said at least one operator controlled movable reflective surface,
F. a signal processor for receiving said generated signals from said stationary light sensor and for processing said generated signals, wherein said processed signals are transmitted to said computer processing unit and are utilized to move said cursor in a manner that corresponds to the motion of said at least one operator controlled movable reflective surface.

2) The pointing device as in claim 1, at least one operator controlled movable reflective surface further comprising a joystick attached to said at least one operator controlled movable reflective surface.

3) The pointing device as in claim 2 further comprising a keyboard for inputting information into said computer processing unit, wherein said joystick is thumb manipulated while the fingers are kept in a typing position and location over said keyboard.

4) The pointing device as in claim 3, wherein said at least one operator controlled movable reflective surface is two operator controlled movable reflective surfaces and said at least one joystick is two joysticks one joystick attached to each of the two operator controlled movable reflective surfaces and wherein the operator controls said two joysticks with his thumbs while the operator's fingers are kept in a typing position and location over said keyboard.

5) The pointing device as in claim 4 wherein said two movable reflective surfaces are the surfaces of two pivot balls, wherein each of said joysticks comprise:
A. a stem connected to said pivot ball, and
B. a thumb shoe connected to said stem,
C. one of the pivot balls.

6) The pointing device as in claim 5, wherein said stems are height adjustable.

7) The pointing device as in claim 5, wherein said stems are collapsible.

8) The pointing device as in claim 4, wherein said point device comprises at least one micro switch for clicking on said computer monitor screen when said micro switch is actuated.

9) The pointing device as in claim 8, wherein said at least one micro switch is thumb actuated by pressing downward on one of said joystick.

10) The pointing device as in claim 3 wherein said joystick is two joysticks and wherein said at least one micro switch is two micro switches, wherein said computer is programmed so that an operator can customize which of said two joysticks controls cursor movement and said operator can customize which of said two micro switches controls a left click function and which controls a right click function.

11) The pointing device as in claim 1, wherein said at least one operator controlled movable reflective surface is curved.

12) The pointing device as in claim 1, wherein said at least one operator controlled movable reflective surface is semi-spherical and further comprising a joystick attached to said semi-spherical at least one operator controlled movable reflective surface.

13) The pointing device as in claim 1, wherein said at least one operator controlled movable reflective surface is a track ball.

14) The pointing device as in claim 1, wherein said stationary light source is an LED light source.

15) The pointing device as in claim 1, wherein said stationary light source is a laser light source.

16) The pointing device as in claim 1, wherein said at least one operator controlled movable reflective surface is flat.

17) The pointing device as in claim 1 wherein said at least one operator controlled movable reflective surface is a pivot ball, said pointing device further comprising:
A. a joystick attached to the top of said pivot ball,
B. a pivot axis,
C. a spring-loaded pivot arm attached to said pivot axis,
D. a pivot ball holder attached to said spring loaded pivot arm, said pivot ball holder for holding said pivot ball, and
E. a micro switch for clicking on said computer monitor screen when said micro switch is actuated, wherein said pivot arm is in operational contact with said micro switch.

18) The pointing device as in claim 1, wherein said computer processing unit is a game console, wherein said computer monitor screen is a game console screen, wherein said cursor is a game character or object, wherein said processed signals are transmitted to said game console and are utilized to move said game character or object in a manner that corresponds to the motion of said at least one operator controlled movable reflective surface.

19) The pointing device as in claim 18, further comprising a joystick attached to said at least one operator controlled movable reflective surface.

20) A joystick for controlling character or object movement on a game console screen, comprising:
A. a game console,
B. a game console screen having a controllable character or object, said game console screen connected to said game console,
C. at least one operator controlled movable reflective surface,
D. a stationary light source for directing light onto said at least one operator controlled movable reflective surface,
E. a stationary light sensor for receiving reflected light from said at least one operator controlled movable reflective surface and for generating signals based on said received reflected light, wherein said generated signals include information representative of the motion of said at least one operator controlled movable reflective surface,
F. a signal processor for receiving said generated signals from said stationary light sensor and for processing said generated signals, wherein said processed signals are transmitted to said game console and are utilized to move said character or object in a manner that corresponds to the motion of said at least one operator controlled movable reflective surface.

21) The pointing device as in claim 1, wherein said at least one operator controlled movable reflective surface further comprises an extension device for controlling said at least one operator controlled movable reflective surface.

22) The pointing device as in claim 21, wherein said extension device is attached to said at least one operator controlled movable reflective surface.

23) The pointing device as in claim 22, wherein said extension device is a joy stick.
